(19) United States
(12) Patent Application Publication
(10) Pub. No.: US 2012/0137269 A1
(43) Pub. Date: May 31, 2012

(54) PROCEDURE FOR THE REALIZATION OF A MULTIMEDIA AND INTERACTIVE SOFTWARE APPLICATION

(75) Inventor: Roberto STANZANI, Indian Rocks Beach, FL (US)

(73) Assignee: Innovative Transmedia Production, Inc., Indian Rocks Beach, FL (US)

(21) Appl. No.: 12/954,705

(22) Filed: Nov. 26, 2010

(51) Int. Cl. G06F 9/44

(52) U.S. Cl. 717/106

(57) ABSTRACT

The procedure (P) for the realization of a multimedia and interactive software application comprises the following steps:
acquiring material relating to at least one existing intellectual product or creation (step 1);
conceiving (step 11) and realizing (step 13) a new multimedia and interactive software application starting with said acquired material;
wherein the realization of said software application comprises the steps of:
processing said acquired material to obtain new multimedia and/or interactive digital contents (step 116);
developing a single general software structure (step 17);
integrating said digital contents with said software structure (step 18).

### BACKGROUND

1. Field

The present invention relates to a procedure for the realization of a multimedia and interactive software application.

2. Description of the Related Art

When a new intellectual entertainment creation is conceived, together with it is generally conceived a so-called “transmedia” project or product which can be represented on different media using different production and manufacturing techniques.

The media and techniques that can be used in a transmedia project/product can comprise, e.g.:

the production of cartoon series for television and feature films for the cinema;

the production and publication of stories by means of comic series or self-concluding graphic tales;

digital comics, consisting of the comics themselves and graphic tales published on paper, converted into digital images and made displayable on digital media such as Web, personal computer, Smart Phones (iPhone©, Android©) and Touch-Tablets (iPad©);

illustrated and non-illustrated children's books;

digital books (e-books), consisting of traditional books published and printed on paper, converted into digital form and usable by means of special readers (Amazon Kindle©) and by means of Smart Phones and Touch-Tablets;

video games of different types and complexity usable by means of different media such as, e.g., personal computer, dedicated console (Playstation©, Xbox©, Wii©), Web, Smart Phones and Touch-Tablets;

toys (action figures, plush toys, etc);

music;

live events such as, e.g., musical or theatre performances;

card games;

merchandising.

To the media and products listed above can also be added the use of social networking portals such as Facebook©, Twitter© or My Space©, by means of which information can be shared relating to the new intellectual creation and products can be promoted such as video games specially designed for the type of online medium/portal.

The means of promoting the contents and the known techniques do however have a number of limits.

In particular, there is limited compatibility, integration and interaction between the media used and between the contents promoted and used by means of such media.

Furthermore, generally speaking, the lack of knowledge on the part of the manufacturers of the most modern techniques and, therefore, of the possibilities and methods for integrating contents of different nature, together with the use of non-standardized and not yet optimized production processes, make it hard to obtain an innovative transmedia product.

The main aim of the present invention is to provide a procedure that allows the realization of a single multimedia and interactive software application that effectively integrates the conventional contents made and promoted by means of the known media and techniques.

Another object of the present invention is to provide a procedure for the realization of a multimedia and interactive software application which allows overcoming the mentioned drawbacks of the state of the art within the ambit of a simple, rational, easy and effective to use as well as low cost solution.

### SUMMARY

The above-indicated objects are achieved by the present procedure for the realization of a multimedia and interactive software application, comprising the following steps:

acquiring material relating to at least one existing intellectual product or creation;

planning and realizing a new multimedia and interactive software application starting with said acquired material;

wherein the realization of said software application comprises the steps of:

processing said acquired material to obtain new multimedia and/or interactive digital contents;

developing a single general software structure;

integrating said digital contents with said software structure.

### BRIEF DESCRIPTION OF THE DRAWINGS

Other characteristics and advantages of the present invention will become more evident from the description of a preferred, but not sole, embodiment of a procedure for the realization of a multimedia and interactive software application, illustrated purely as an example but not limited to the annexed drawings in which:

FIG. 1 is a general block diagram which shows the procedure according to the invention;

FIG. 2 is a block diagram which shows in detail the steps of the procedure according to the invention for the realization of a demo video of the software application;

FIG. 3 is a block diagram which shows in detail the steps of the procedure according to the invention for the realization of the software application.

### DETAILED DESCRIPTION

With particular reference to such figures, globally indicated by P is a procedure for the realization of a multimedia and interactive software application.

Preferably, the procedure P concerns the realization of software applications for devices such as Smart Phones (iPhone©, Android©) and Touch-Tablets (iPad©) and, if necessary, for personal computers or play consoles (Playstation©, Xbox©, Wii©).

The software application made using the procedure P is composed of a container (general software structure) dedicated to the totally interactive management of digital contents relating to intellectual creations and original products and/or made from already-made material.

For example, the software application can be created starting with existing comics and can comprise the same tables conveyed in digital format, wherein each of the cartoons is processed and transformed into multimedia and interactive contents by means of the realization and integration of animations, sounds, voices, video games, etc.

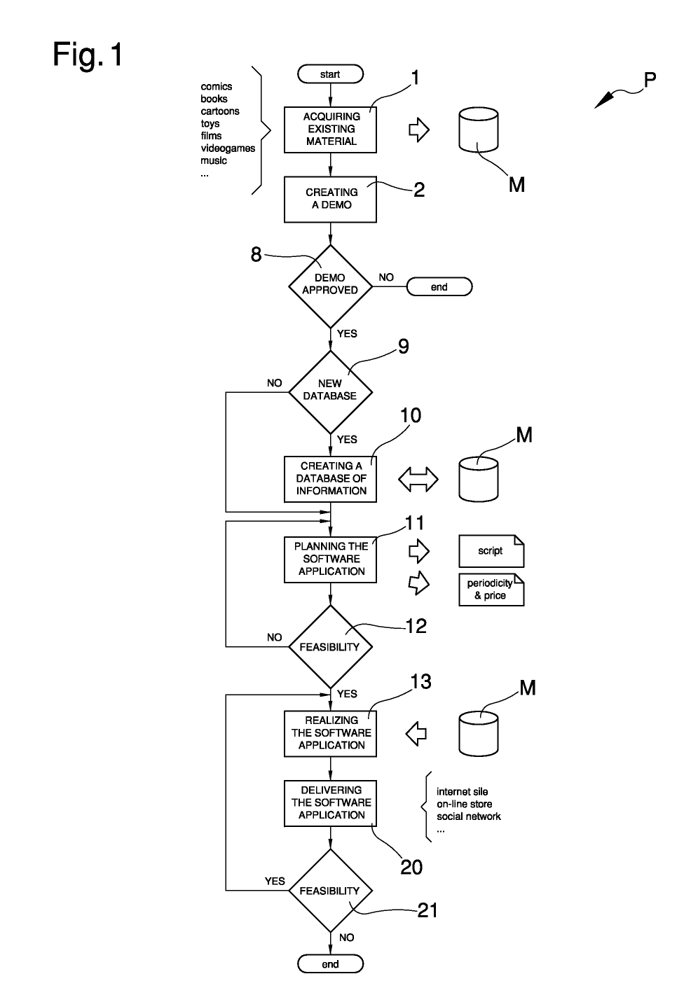

As shown in FIG. 1, the procedure P first of all envisages the acquisition of material relating to at least one product or at least an existing intellectual creation (step 1).

More specifically, by the wording “intellectual creation” is meant everything obtained by a creative process such as, for example, fantasy characters, settings, subjects, etc.

By the wording “existing material” is also meant all the original works as a whole relating to such intellectual creation, comprising, for example, comics, books, cartoons, toys, films, video games, music, party games and card games.

The acquisition of the existing material (step 1) comprises, in particular, the conversion of such material into digital format and the storing of the material thus converted onto a storage unit M, of the mass-memory type or the like.

Usefully, the procedure P envisages a preliminary phase of creation of a demo video of the software application to be made (step 2), fundamental for the editor/customer to understand how the software application might be before it is made in all its parts.

The demo video, for example, can consist of the original revision and reprocessing of the acquired existing material, to obtain a non-interactive video which however simulates all the interactive potential of the finished software application.

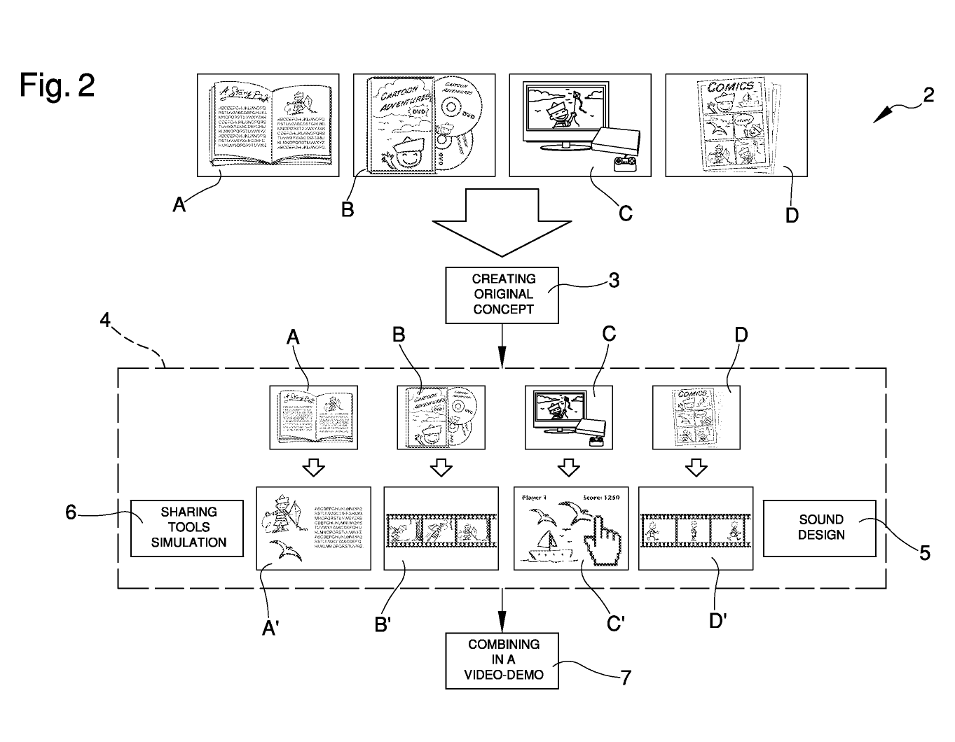

The demo video realization phase is further detailed in FIG. 2.

In particular, such phase comprises the creation of an original concept (step 3) starting with the existing material, composed for example of books, cartoons, video games or multimedia contents in general and comics (indicated by the references A, B, C, and D in FIG. 2).

This is followed by a step of development of the original concept (step 4), wherein the existing material A, B, C and D, once acquired and stored in the storage unit M, is reprocessed to make, for example:

digital illustrations and text A′ obtained starting with the books A;

animated sequences B′ taken from the cartoons B;

original animated sequences C′ obtained starting with the multimedia contents C;

original animated sequences D′ obtained starting with the comics D.

The development of the original concept (step 4) can also envisage the creation of sound and music effects (step 5) or the simulation of sharing/distribution of the software applications (step 6) by means, e.g., of a purposely created website, through On-Line Store (iTune Store©, OVI Store© or, again, through social networking portals (Facebook©, Twitter© or My Space©).

Finally, the newly-created video and audio material is then combined to make the demo video (step 7).

At this point, the customer must decide whether to approve the realization of the software application or not (step 8).

If necessary, in this phase, the customer can suggest modifications to the demo and, therefore to the software application to be made.

Usefully, the procedure P can comprise, on request of the editor/customer (step 9), the setting up of a new database (step 10) by means of which the acquired material is organized and if necessary integrated with new material, made with or without the support of the authors of the intellectual creation and of the original material.

This way, on request of the customer, a general documentation can be produced that fully describes all the original and non-original contents relating to a determinate intellectual creation (or to several intellectual creations that are linked or can be linked together).

Such documentation can be used to make the new multimedia application by means of the procedure P and/or to make new products of traditional type.

The material thus organized and integrated can be stored in the same storage unit M.

The procedure P also comprises the conceiving of the new software application starting with the acquired and integrated material (step 11).

During this phase, in particular, all the material at disposal is analyzed and, by means of a creative process, the following can be defined:

at least one narrative, if necessary split into several episodes;

the frequency of publication of the episodes (if several episodes can be created) and the total price of the software application for users.

Afterwards, a feasibility study is performed for the software application on the basis of the expected costs and realization times and type of necessary activities and skills (step 12).

If the software application, as it is conceived, is not deemed feasible, then the conceiving phase is repeated (step 11).

Otherwise, the actual realization of the software application starts (step 13).

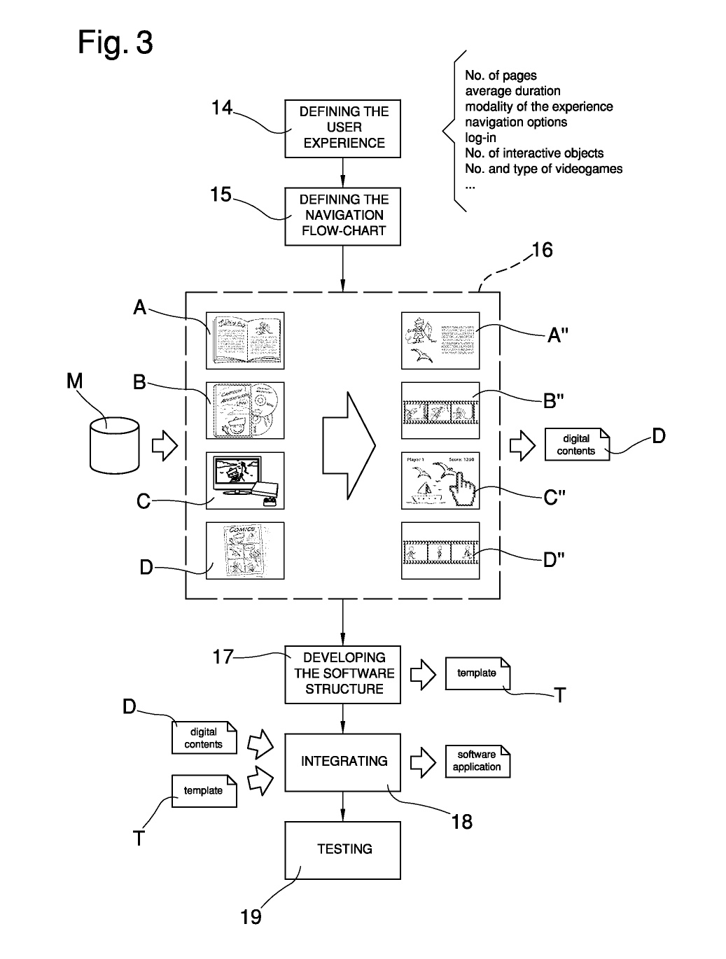

FIG. 3, in particular, shows in detail all the steps leading to the realization of the software application.

First of all, that which will be the play experience of the user is defined (step 14) in terms of parameters such as, e.g.:

the number of pages/display pages to be displayed;

the average duration of the experience;

the experience procedures;

the surfing options (e.g., start/stop of music, voices, texts, balloons);

the log-in procedures;

the quantity of interactive objects (e.g., “Easter-Eggs”);

the quantity of interactive sequences and the quantity and type of video games.

In particular, with the wording “experience procedures” is meant the possibility for the user to select different ways of displaying the contents of the software application such as, e.g.:

a classic mode, wherein the contents are static (digital book/comics type) and no interactions are envisaged on the part of the user;

a motion mode, wherein a film is displayed and wherein no interactions are envisaged on the part of the user;

and an interactive mode, wherein all the interactions are allowed provided by the software application.

Subsequently, the software application surfing flow-chart is defined (step 15), meaning the sequence of video/images to be displayed and the sequence of interactions that can be selected by the user.

The procedure P subsequently envisages the processing of the acquired (and if necessary integrated) material to obtain new multimedia and/or interactive digital contents D (step 16).

In particular, by the wording “digital contents” is meant all those contents obtainable in a direct and indirect way from the acquired material, such as, e.g., animated sequences, graphic material (e.g., usable for the graphic interface), illustrative material (illustrations, backgrounds, graphic elements), texts, music, sound effects, voices and video games.

In FIG. 3 is schematized the acquired material processing step (step 16) and, in particular, this step envisages the processing of the existing material A, B, C and D to realize digital contents such as, e.g., digital illustrations and text A″, animated sequences B″ taken from the existing material, video games C″, original animated sequences D′, etc.

The acquired material processing step (step 16) can also envisage the creation of sound effects and original music or the creation of components for sharing/distributing the software application by means, e.g., of a specially created website, through On-Line Store (iTune Store©, OVI Store( ) or, again, through social networking portals (Facebook©, Twitter© or My Space©).

Realizing the software application also envisages the development of a single general software structure (step 17), generically indicated in the illustration by the template T, and the integration of the digital contents D realized inside such general structure T (step 18) to obtain the finished software application.

In point of fact, e.g., from a comic table printed on paper or from cartoon sequences, real toys, or from a children's book, the various contents are analyzed, separated and rebuilt using digital animation techniques to obtain the digital contents D which, subsequently, are integrated the one with the other inside a general software structure T which manages their reproduction and interaction with the choices of the user.

The same contents are also converted into elements useful for the realization of video games, these too integratable inside the software application structure.

The resulting software application can be used on various platforms such as Smart Phones (iPhone©, Android©), Touch-Tablets (iPad©), personal computers or play consoles (Playstation©, Xbox©, Wii©), after changing and re-coding the code.

Finally, the realization phase ends with the testing of the software application made (step 19).

As shown in FIG. 1, the procedure P comprises the distribution of the software application made (step 20) which can be done, e.g., through a purposely-created website, through On-Line Store (iTune Store©, OVI Store©) or, again, through social networking portals (Facebook©, Twitter© or My Space©).

Finally, if the software application is split into different episodes to be published separately and periodically (step 21), the realization (step 13) and the distribution (step 20) are repeated iteratively for each of the conceived episodes.

It has in point of fact been ascertained how the described invention achieves the proposed objects.

In particular, the fact is underlined that the procedure according to the invention allows the realization of a single multimedia and interactive software application that effectively integrates the contents of conventional type normally realized and distributed by means of the known media and techniques.

The software application obtained by means of the procedure according to the invention, furthermore, provides a level of interactivity dedicated to all the different media much higher than that known up to now.

1. Procedure for the realization of a multimedia and interactive software application, comprising the following steps:
acquiring material relating to at least one existing intellectual product or creation;
conceiving and realizing a new multimedia and interactive software application starting with said acquired material;
wherein the realization of said software application comprises the steps of:
processing said acquired material to obtain new multimedia and/or interactive digital contents;
developing a single general software structure;
integrating said digital contents with said software structure.

2. Procedure according to the claim 1, wherein said existing material comprises at least an intellectual creation selected amongst: comics, books, cartoons, toys, films, video games, music, party games and card games.

3. Procedure according to the claim 1, characterized by the fact that said digital contents comprise at least a content selected amongst: animated sequences, graphic material, illustrative material, texts, music, sound effects, voices and video games.

4. Procedure according to the claim 1, wherein said step of acquisition comprises the conversion of the existing material into a digital format.

5. Procedure according to the claim 4, wherein said step of acquisition comprises the storing of the material converted into digital format onto at least a storage unit.

6. Procedure according to the claim 1, comprising the following steps:
creating an original concept starting with said acquired material;
realizing digital illustrations and/or animated sequences starting with said original concept and with said acquired material;
combining said digital illustrations and said animated sequences to make a demo video of said software application.

7. Procedure according to the claim 1, comprising the step of setting up a new database wherein said acquired material is organized and/or integrated with new material.

8. Procedure according to the claim 1, wherein said step of conceiving comprises the definition of at least a narrative starting with said acquired material.

9. Procedure according to the claim 1, wherein said step of conceiving comprises the step of determining the number of episodes making up said narrative and the frequency of publication of said episodes.

10. Procedure according to the claim 1, comprising the step of determining the price of said software application and the payment terms.

11. Procedure according to the claim 1, comprising the step of deeming the feasibility of the software application.

12. Procedure according to the claim 1, wherein said step of realizing the software application comprises the definition of at least one of the following parameters: number of pages/display pages, average duration of the experience, experience procedures, surfing options, log-in procedures, quantity of interactive objects, quantity of interactive sequences, quantity and type of video games.

13. Procedure according to the claim 1, wherein said step of realizing the software application comprises the step of defining the surfing flow-chart of the software application.

14. Procedure according to the claim 1, wherein said step of realizing the software application comprises the testing of said software application made.

15. Procedure according to the claim 1, comprising the step of distributing said software application made.

16. Procedure according to the claim 9, comprising the repetition of said step of realizing the software application for each of said determined episodes.
